(19) United States
(12) Patent Application Publication
(10) Pub. No.: US 2007/0076552 A1
(43) Pub. Date: Apr. 5, 2007

(54) Parameter updating methods and systems for optical disc accessing

(76) Inventors: Ming-Yang Chao, Chudung Chen (TW); Chih-Ching Chen, Lioujiou Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/243,066

(22) Filed: Oct. 4, 2005

(51) Int. Cl. G11B 27/36

(52) U.S. Cl. 369/53.3

(57) ABSTRACT

Methods and systems for dynamically updating velocity dependent parameters during optical disc accessing are provided. A velocity estimator estimates a current velocity of a rotating disc. A storage unit stores a plurality set of parameters, each set corresponds to a preset velocity, and a register stores velocity dependent parameters that are currently used for data recording. A batch controller retrieves a set of parameters from the storage unit according to the current velocity estimated by the velocity estimator, and updates the velocity dependent parameter stored in the register using the parameters retrieved from the storage unit.

### BACKGROUND

The invention relates to optical disc accessing, and more specifically, to methods and systems for dynamically updating parameters while accessing data from an optical disc with more than one rotation speed.

With the increase of demand for optical disc reading and writing at a high speed with high density, the original constant linear velocity (CLV) data accessing technique has become inefficient due to high latency at outer tracks. A constant angular velocity (CAV) data accessing technique maintains rotational speed by applying the same speed to turn the disc 360° regardless of pickup head position. A basic clock frequency of a recording/reproduction signal changes in accordance with the pickup head position. Since the circumference of the inner tracks of the disc is far less than the outer tracks, this constant speed means that when the heads are on the outer tracks they traverse a much longer linear path than they do when on the inner tracks. Hence, the linear velocity is not constant as it varies during recording or reproduction, thus, more information may be stored on the outer tracks.

Write strategy and other velocity related parameters must be adaptively adjusted in accordance with the linear velocity to maintain an acceptable recording quality. The microprocessor takes a significant period of time to update the write strategy, and after all the relevant parameters have been updated, the disc has already been written with partial “out of date” write strategy for quite a while, resulting excessive C1/C2 errors or PI/PO errors.

In U.S. Pat. No. 6,535,470, two buffers 142-1 and 142-2 are used for storing write signal control values. A switching control bit 172 determines which buffer is loaded with write signal control values and which buffer supplies write signal control values to the parameter generator 154. One of the buffers supplies the current write signal control values while the other is loaded with the next set of write signal control values, and when the write strategy needs to be switched as the velocity change has reached a threshold, the instantaneous switching between the two buffers avoids the drawback of a long period for write strategy updating.

Similarly, a published U.S. patent application US 2002/0159352 also discloses an optical disc recording apparatus, comprising a strategy information storage unit having a plurality of storage units. Each storage unit memorizes the write strategy successively generated by a strategy generator, which allows a pulse generator to generate a pulse waveform shaped according to an updated strategy retrieved from one of the storage units.

### SUMMARY

Embodiments of an optical disc accessing system comprise a velocity estimator, a storage unit, a register, and a batch controller. The velocity estimator estimates a current velocity of a rotating disc. The storage unit stores at least a set of parameters, where each set of parameters corresponds to a preset velocity. The register stores at least a velocity dependent parameter. The batch controller retrieves a set of parameters from the storage unit according to the current velocity estimated by the velocity estimator, and updates the velocity dependent parameter stored in the register using the parameters retrieved from the storage unit.

In some embodiments, the velocity dependent parameter comprises write strategy parameters, and the optical disc accessing system further comprises a write strategy wave generator generating a laser power control signal according to the write strategy parameters. The velocity estimator may be either a velocity detector or a location detector. In some embodiments, the location detector determines the currently accessed location based on a physical address extracted from an ATIP (Absolute Time in Pre-groove) time code.

Embodiments of a dynamically updating method for optical disc accessomg comprise estimating a current velocity of a rotating disc, providing a table storing a set of parameters corresponding to each preset velocity, and retrieving a set of parameters from the table according to the current velocity. The retrieved parameters are used for updating a velocity dependent parameter stored in a register. The disc is reading or writing based on the velocity dependent parameter stored in the register.

### DESCRIPTION OF THE DRAWINGS

The invention can be more fully understood by reading the subsequent detailed description in conjunction with the examples and references made to the accompanying drawings, wherein:

FIG. 1 shows an exemplary CD-R write strategy.

FIG. 2 shows an embodiment of the optical disc accessing system capable of updating write strategy in a CAV mode.

FIG. 3 is a timing diagram showing an exemplary procedure for updating velocity dependent parameters.

FIG. 4 shows exemplary definitions for defining parameters stored in the DRAM.

FIG. 5 shows an embodiment of a batch controller.

FIG. 6 shows a flowchart of an embodiment of a dynamic parameter updating method.

### DETAILED DESCRIPTION

Dynamic parameter updating methods and systems for optical disc accessing are provided. In an optical disc accessing system, an encoder encodes data bytes to generate an internal EFM (eight-to-fourteen modulation) signal for a specified velocity. Laser power control signals are generated from the internal EFM signal and write settings depending on the specified velocity, which determines the shape of the laser pulse that forms pits and lands on the optical disc. The laser pulse control for disc recording is also referred to as write strategy. Embodiments of the optical disc accessing system adjust various write strategy parameters adaptively while the disc is rotated at a constant angular velocity. The controlling factor in formation of the mark is how the media reacts to heating by the laser. For example, to make a mark of 3 T in length on a CD-R disc, the laser is switched to 12 mW for ½ T and then to 10 mW for ½ T. The initial high power is designed to quickly heat the optical disc from ambient temperature to the mark formation temperature. The power is then reduced to continue mark formation but is switched off before 3 T has elapsed because residual heat from the writing process will make the mark longer than the 2 T that the laser was actually turned on. At higher writing speeds, the optical disc must be heated in a shorter time so that the starting power will be increased in length and amplitude. Formation of marks other than 3 T will use slightly different strategies. For some other recordable or rewritable discs, the laser is not only modulated off and on for disc recording, it is also modulated between write, erase, and bias laser powers.

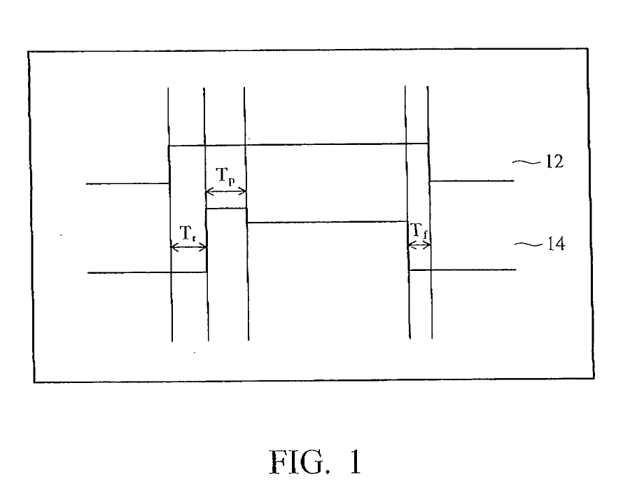

FIG. 1 shows an exemplary write strategy for CD-R. Write strategy parameter T defines the delay time from the rising edge of the internal EFM signal 12 to the rising edge of the laser power control signal 14. Write strategy parameter Tₚ defines the pulse width which has a slightly higher power level in the laser power control signal 14. Write strategy parameter Tₜ defines the time between the falling edge of the laser power control signal 14 and the falling edge of the internal EFM signal 12.

The optical disc accessing system reduces the time required for updating velocity dependent parameters in a CAV mode with a single storage unit. Conventionally, the velocity dependent parameters such as write strategy parameters are updated or adjusted through a microprocessor. The velocity dependent parameters are sometimes computed by interpolation, which consumes a number of machine cycles as it requires complicated calculation executed by the firmware to generate each of the parameters corresponding to the new linear velocity. In practice, the updating time is intolerable with respect to the recording speed since there are a great number of parameters depending on the rotating velocity.

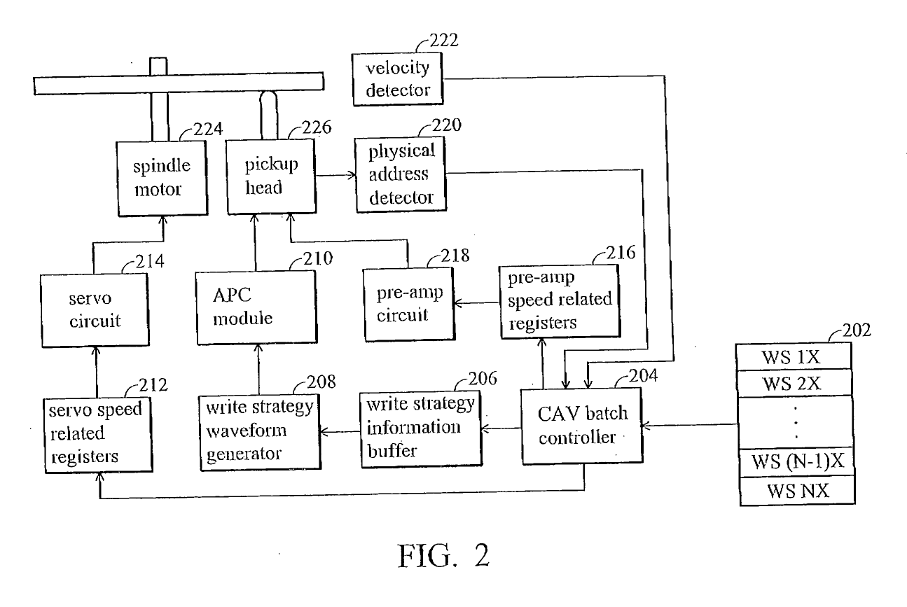

FIG. 2 shows an embodiment of the optical disc accessing system allowing rapid parameter updating in a CAV mode. The optical disc accessing system comprises a storage unit 202 storing sets of parameters, where each set corresponds to a preset linear velocity. A set of parameters may include write signal control values which determine write strategy parameters for a specified disc type at a specified linear velocity. In some embodiments, the storage unit 202 is a write strategy table having entries corresponding to various preset linear velocities 1X, 2X, . . . , (N−1)X, and NX. The term “NX” refers to the specified constant linear velocity of the disc equal to N times the base constant linear velocity 1X. Each set of parameters stored in the storage unit 202 is associated with a range of linear velocities as there are acceptable tolerances in the size of the marks and fluids. Thus, the preset linear velocities define the boundary of each velocity range with velocities that share the same velocity dependent parameters. In some embodiments, the storage unit 202 is a dynamic random access memory (DRAM) which records the parameters corresponding to different linear velocities in different banks or in the same bank.

A CAV batch controller 204 retrieves a set of parameters from the storage unit 202 and provides related parameters to each register and buffer so that various velocity dependent parameters may be promptly updated when a velocity estimator such as a velocity detector 222 or a physical address detector 220 detects that the current velocity exceeds the velocity range corresponding to the currently used set of parameters. For example, the velocity detector 222 or the physical address detector 220 notifies the CAV batch controller 204 to update the velocity dependent parameters when the linear velocity had increased from 2X to 3X. The CAV batch controller 204 retrieves the set of parameters corresponding to 3X from the storage unit 202 and renews corresponding registers.

In some embodiments, the parameters stored in the storage unit 202 are differentiated values, so that the CAV batch controller 204 updates the velocity dependent parameters by performing some calculations such as adding or subtracting the differentiated value to/from the original velocity dependent parameters stored in the corresponding registers.

The physical address detector 220 determines the current accessing location by detecting and extracting an Absolute Time in Pre-groove (ATIP) time code of a CD-R/RW disc, Address in Pre-groove (ADIP) bits of a DVD+R/RW disc, or Land Pre-pit (LPP) bits of a DVD-R/RW disc. In an embodiment of recording data on a CD-R disc, the physical address detector 220 outputs an ATIP time code extracted from the disc to the CAV batch controller 204. Each set of parameters stored in the storage unit 202 corresponds to a preset ATIP time code, so that the CAV batch controller 204 retrieves a set of parameters from the storage unit 202 based on the ATIP time code extracted by the physical address detector 220.

Some examples of the registers storing velocity dependent parameters shown in FIG. 2 include a write strategy information buffer 206, pre-amp speed related registers 216, and servo speed related registers 212. These buffers or registers provide velocity dependent parameters to corresponding modules such as a write strategy waveform generator 208, a pre-amp circuit 218, and a servo circuit 214, and the most recently updated velocity dependent parameters will be used by these corresponding modules for disc accessing.

For example, the automatic power calibration (APC) module 210 controls the power of the laser beam emitted from the pickup head 226 according to a laser power control signal generated by the write strategy waveform generator 208. The servo circuit 214 may perform focusing servo control, tracking servo control, and seeking servo control for the sled motor, fine actuator, and lens. In some embodiments, the servo circuit 214 may perform spindle control, as shown in FIG. 2, the servo circuit 214 controls the spindle motor 224 according to the velocity dependent parameters stored in the servo speed related registers 212. The pre-amp circuit 218 generates a control signal according to the parameters stored in the pre-amp speed related registers 216, and provides the control signal to a power driver for driving the actuator and lens in the pickup head 226.

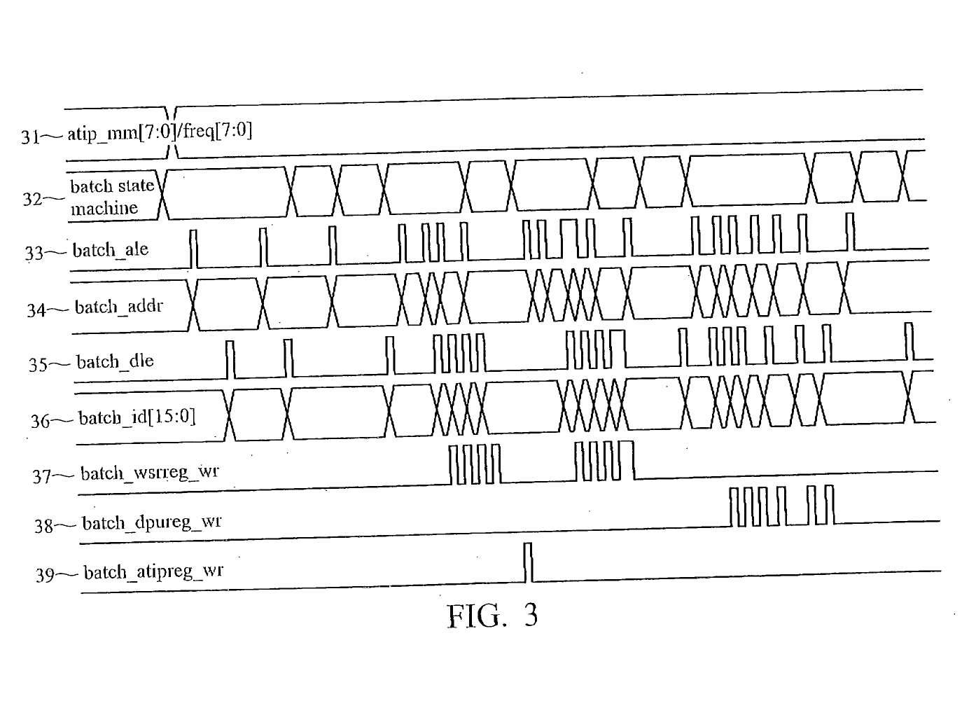

FIG. 3 is a timing diagram showing an exemplary procedure for updating CAV parameters. In this embodiment, the parameters such as the write strategy parameters are switched or updated when the time indicated by the ATIP time code 31 increases by one minute. Parameters are stored in a DRAM in this embodiment. When the minute counter of the ATIP time code 31 triggers a transition, the CAV batch controller is initiated to retrieve corresponding parameters stored in the DRAM. As shown in the first state of the batch state machine 32, the CAV batch controller searches the actual location of the parameter table stored in the DRAM according to the current ATIP time code. The CAV batch controller then starts fetching commands by directing to the corresponding parameter storage block. As shown in FIG. 3, the CAV batch controller fetches parameters related to write strategy, and begins providing the write strategy parameters to corresponding registers (signal 37). The CAV batch controller then fetches parameters for ATIP related registers, and provides these parameters to update the parameters stored in the ATIP register (signal 39). The CAV batch controller also updates DPU related parameters (signal 38). The CAV batch controller can update any register via its normal reading or writing operation without designing or building new scheme for parameter updating.

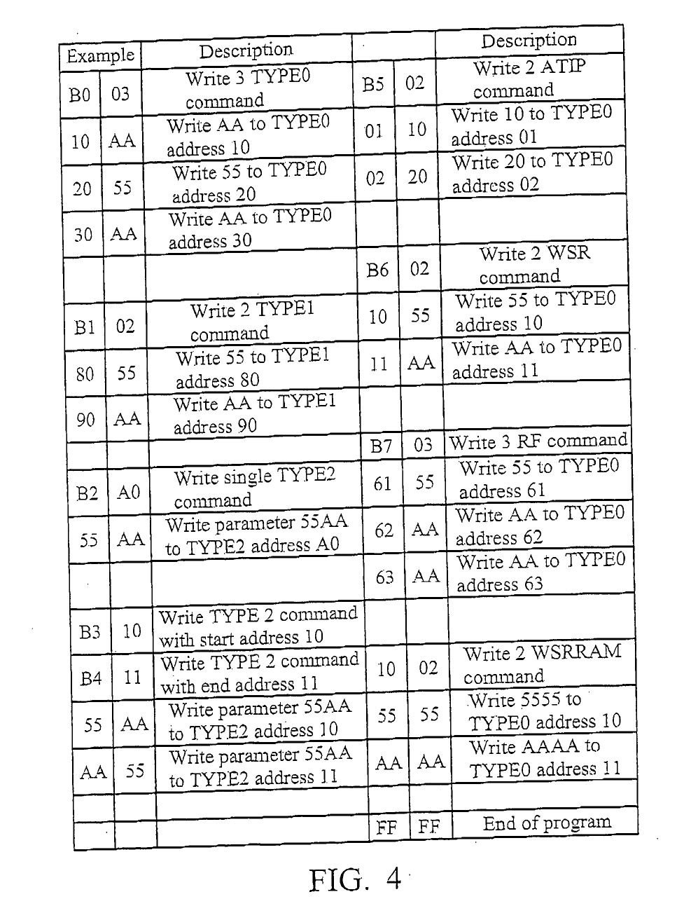

FIG. 4 shows exemplary definitions for defining parameters stored in the DRAM. In this example, an instruction code and an instruction number are used to define a bank and an address that are corresponding to data to be written in related buffer or register. For example, B0-B4 indicates that the command is for the DSP, similarly, B5 corresponds to an ATIP related register, B5 corresponds to a write strategy register, B7 corresponds to a pre-amp related register, and 10 corresponds to write strategy information buffer. FF indicates the end of the instruction.

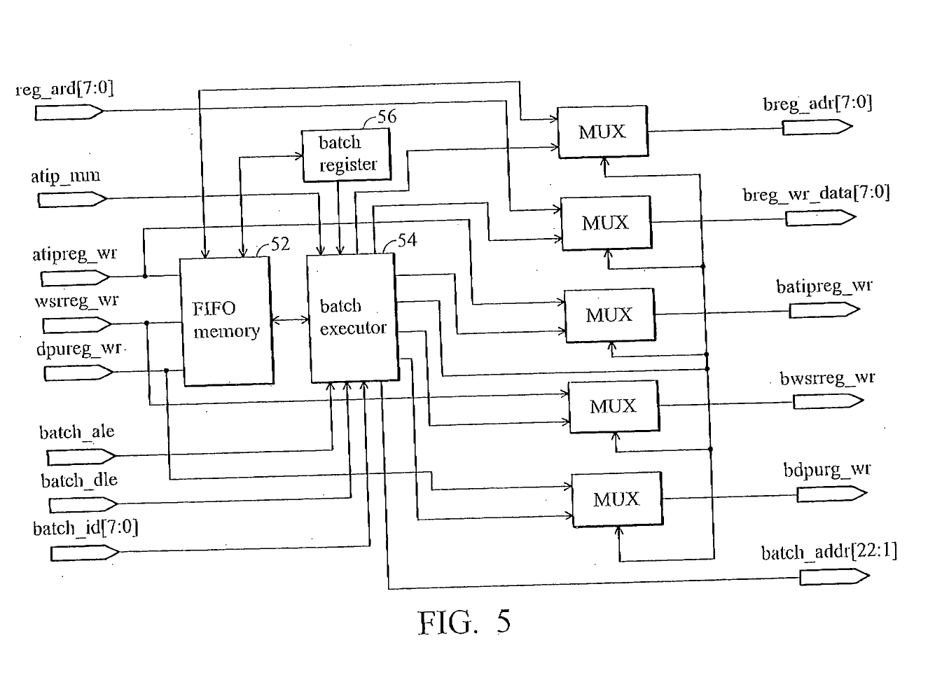

FIG. 5 shows an embodiment of a batch controller. A first in first out (FIFO) memory 52 buffers write commands sent from a microprocessor for each bank register. The batch controller provides the updated parameters to each bank register while the microcontroller sends the write comments, thus, the FIFO memory 52 buffers these write comments, and switches to process the comments of the microprocessor when the FIFO memory 52 is nearly full. A batch executor 54 is responsible for decoding the instructions of the DRAM and generates a write operation for a corresponding register.

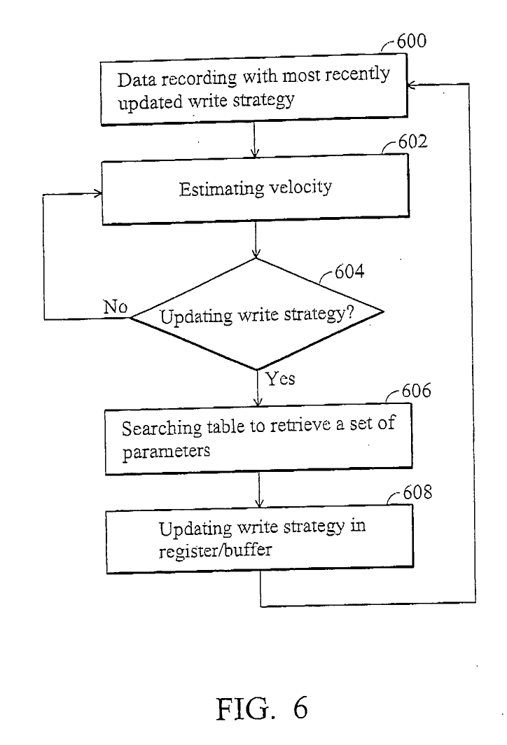

FIG. 6 shows a flowchart of an embodiment of a dynamic parameter updating method. This embodiment is for writing data on an optical disc, however, the dynamic parameter updating method is not limited to data recording, and those skilled in the art should be able to apply the updating method for reading data from the optical disc. The optical disc drive performs data recording (step 600), and the current linear velocity of the disc is monitored (step 602). A table stores a set of parameters for each preset velocity, where the preset velocity defines the boundary for switching the write strategy. When the current linear velocity reaches another preset velocity, it indicates that the write strategy needs to be updated (step 604). A set of parameters corresponding to the current velocity is retrieved from searching the table (step 606). Te retrieved parameters are used to update the write strategy stored in registers and buffers (step 608). The subsequent data recording is then performed utilizing the most recently updated write strategy (step 600).

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical disc accessing system, comprising:
a velocity estimator, estimating a current velocity of a rotating disc;
a storage unit, storing at least a set of parameters, wherein each set of parameters corresponds to a preset velocity;
a register, storing at least a velocity dependent parameter; and
a batch controller, retrieving a set of parameters from the storage unit according to the current velocity estimated by the velocity estimator, and updating the velocity dependent parameter stored in the register using the parameters retrieved from the storage unit.

2. The optical disc accessing system according to claim 1, further comprising a write strategy wave generator coupled to the register, generating a laser power control signal according to the velocity dependent parameter stored in the register.

3. The optical disc accessing system according to claim 2, wherein the register is a write strategy information buffer, storing write strategy parameters and laser power for disc recording.

4. The optical disc accessing system according to claim 1, further comprising a servo circuit coupled to the register, executing servo control in accordance with the velocity dependent parameter stored in the register.

5. The optical disc accessing system according to claim 4, wherein the servo control executed by the servo circuit comprises focusing servo control, tracking servo control, seeking servo control, and spindle control.

6. The optical disc accessing system according to claim 1, further comprising a pre-amplifier circuit coupled to the register, wherein coefficients of the pre-amplifier circuit is determined in accordance with the velocity dependent parameter stored in the register.

7. The optical disc accessing system according to claim 1, wherein the parameters stored in the storage unit are differentiated values, and the batch controller updates the velocity dependent parameter by adding or subtracting the differentiated value to/from the original velocity dependent parameter stored in the register.

8. The optical disc accessing system according to claim 1, wherein the batch controller retrieves a set of parameters and updates the velocity dependent parameter accordingly when the batch controller determines that the current velocity reaches another preset velocity which corresponds to a different set of parameters.

9. The optical disc accessing system according to claim 1, wherein the velocity estimator comprises a velocity detector detecting a linear velocity of the rotating disc.

10. The optical disc accessing system d according to claim 1, wherein the velocity estimator comprises a location detector which estimates the current velocity according to a current accessing location of the disc.

11. The optical disc accessing system according to claim 10, wherein the location detector determines the current accessing location based on a physical address extracted from an Absolute Time in Pre-groove (ATIP) time code, Land Pre-pit (LPP) bits, or Address in Pre-groove (ADIP) bits.

12. The optical disc accessing system according to claim 1, wherein the velocity estimator outputs an ATIP time code extracted from the disc as the current velocity, each set of parameters stored in the storage unit corresponds to an ATIP time code, and the batch controller retrieves a set of parameters from the storage unit based on the extracted ATIP time code.

13. The optical disc accessing system according to claim 1, wherein the storage unit is a Dynamic Random Access Memory (DRAM) storing a write strategy table, and each entry of the write strategy table comprises a set of parameters and its corresponding velocity.

14. The optical disc accessing system according to claim 1, wherein the disc is rotated at a constant angular velocity (CAV).

15. The optical disc accessing system according to claim 1, wherein the parameters stored in the storage unit comprises instruction codes and instruction numbers, each defining a bank, address, or data to be written into the register.

16. The optical disc accessing system according to claim 15, wherein the batch controller comprises:
a first in first out (FTIFO) buffer, buffering a write command for switching the velocity dependent parameter stored in the register; and
a batch executor, decoding the instruction codes retrieved from the storage unit and generating a corresponding command for updating the register.

17. A dynamic parameter updating method for optical disc accessing, comprising:
estimating a current velocity of a rotating disc;
providing a table storing a set of parameters corresponding to each preset velocity;
retrieving a set of parameters from the table according to the current velocity;
updating a velocity dependent parameter stored in a register with the retrieved parameters; and
performing disc accessing based on the velocity dependent parameter stored in the register.

18. The dynamic parameter updating method according to claim 17, further comprising generating a laser power control signal in accordance to the velocity dependent parameter, and emitting a laser beam for disc accessing according to the laser power control signal.

19. The dynamic parameter updating method according to claim 18, wherein the velocity dependent parameter comprises write strategy parameters and laser power for disc recording.

20. The dynamic parameter updating method according to claim 17, further comprising executing servo control in accordance with the velocity dependent parameter.

21. The dynamic parameter updating method according to claim 20, wherein the servo control comprises focusing servo control, tracking servo control, seeking servo control, and spindle control.

22. The dynamic parameter updating method according to claim 17, wherein the velocity dependent parameter is updated according to the retrieved parameters when the current velocity reaches another preset velocity which corresponds to a different set of parameters.

23. The dynamic parameter updating method according to claim 17, wherein the current velocity is estimated by detecting a linear velocity of the rotating disc.

24. The dynamic parameter updating method according to claim 17, wherein the current velocity is estimated according to a current accessing location of the disc.

25. The dynamic parameter updating method according to claim 24, wherein the current accessing location is determined based on a physical address extracted from an ATIP (Absolute Time in Pre-groove) time code.

26. The dynamic parameter updating method according to claim 17, wherein the disc is rotated at a constant angular velocity (CAV).

27. The dynamic parameter updating method according to claim 1, wherein the parameters stored in the table comprise instruction codes and instruction numbers, each defining a register and related address or data to be written into the register.

28. The dynamic parameter updating method according to claim 27, further comprising:
buffering a write command for switching the velocity 41 dependent parameter stored in the register;
decoding the retrieved instruction codes; and
generating a corresponding command for updating the register based on the decoded instruction codes.
